(19) United States
(12) Patent Application Publication
(10) Pub. No.: US 2015/0039179 A1
(43) Pub. Date: Feb. 5, 2015

(54) AGRICULTURAL EQUIPMENT FLUID DELIVERY SYSTEM

(71) Applicant: Parker-Hannifin Corporation, Cleveland, OH (US)

(72) Inventor: Brian Boothe, Nacogdoches, TX (US)

(21) Appl. No.: 14/445,533

(22) Filed: Jul. 29, 2014

Related U.S. Application Data
(60) Provisional application No. 61/860,349, filed on Jul. 31, 2013.

(51) Int. Cl. A01C 23/00; A01C 21/00; A01C 23/02

(52) U.S. Cl. CPC A01C 23/007; A01C 23/024; A01C 21/002
USPC 701/34.4; 111/120

(57) ABSTRACT

Provided is agricultural equipment for delivering fluid to a field. The agricultural equipment includes a system having a plurality of flow indicator sensors for providing an output indicative of whether or not fluid is flowing through the sensors above or below a prescribed rate and an indicator panel for providing at least one of a visual or an audio indication to an operator indicative of whether or not fluid is flowing through the flow indicator sensors above or below the prescribed rate. The indicator panel may be provided in a location to allow an operator to determine when an interruption occurs, for example by viewing a visual indication on the indicator panel, without the operator having to look away from a direction of motion. In this way, the operator can safely and efficiently determine if there is an interruption and then take the necessary steps to clear the interruption.

### RELATED APPLICATIONS

This application claims the benefit of U.S. Provisional Application No. 61/860,349 filed Jul. 31, 2013, which is hereby incorporated herein by reference.

### FIELD OF INVENTION

The present invention relates generally to agricultural equipment, and more particularly to agricultural equipment for delivering fluid, such as anhydrous ammonia to a field.

### BACKGROUND

Anhydrous ammonia may be applied to soil by farmers as a fertilizer. Farmers often use a nurse tank containing pressurized liquid anhydrous ammonia as a source. The nurse tank may be provided on a cart that is transported by a farm vehicle, such as a tractor, across a field while the anhydrous ammonia is distributed to the soil via a tool bar connected to the nurse tank. One or more hoses may be used to connect the nurse tank and the tool bar. The one or more hoses may be coupled to the nurse tank, and more particularly to a withdrawal valve of the nurse tank and/or the tool bar in any suitable manner, such as by couplers configured to be threaded together, such as acme couplers.

### SUMMARY OF INVENTION

The present invention provides agricultural equipment for delivering fluid to a field. The agricultural equipment includes a system having a plurality of flow indicator sensors for providing an output indicative of whether or not fluid is flowing through the sensors above or below a prescribed rate and an indicator panel for providing at least one of a visual or an audio indication to an operator indicative of whether or not fluid is flowing through the flow indicator sensors above or below the prescribed rate. The indicator panel may be provided in a location to allow an operator to determine when an interruption occurs, for example by viewing a visual indication on the indicator panel, without the operator having to look away from a direction of motion. In this way, the operator can safely and efficiently determine if there is an interruption and then take the necessary steps to clear the interruption.

According to one aspect of the invention, a system for delivering fluid to a field using an agricultural implement is provided. The system includes a plurality of laterally spaced applicators, a manifold connectable to a source of fluid to be delivered to the field, a plurality of lines, each line connecting the manifold to a respective one of the plurality of applicators, a plurality of flow indicator sensors, each flow indicator sensor being connectable between the manifold and a respective one of the plurality of lines and configured to provide an output indicative of whether or not fluid is flowing through the sensor at a prescribed rate, and an indicator panel for receiving the output from the plurality of flow indicator sensors and for providing at least one of a visual or an audio indication to an operator based on the outputs.

The indicator panel provides a visual indication for each of the plurality of flow indicator sensors based on the outputs of the respective flow indicator sensors.

The indicator panel includes an indicator for each of the plurality of flow indicator sensors.

The indicators are light-emitting diodes.

The system further includes wires connecting the plurality of flow indicator sensors to the indicator panel.

The system further includes a junction box, wherein the wires include a wire connecting each of the flow indicator sensors to the junction box and a wire connecting the junction box to the indicator panel.

The system further includes a cable having one end coupled to the indicator panel and another end configured to be coupled to a battery to provide power to the indicator panel.

Each flow indicator sensor has a cable coupled thereto that has a connector configured to mate with a corresponding connector coupled to a respective one of the wires.

The indicator panel further includes a power switch, indicia identifying each of the plurality of applicators, and one or more connectors configured to couple to the wires.

Each flow indicator sensor includes a body having a first end configured to be coupled to the manifold, a second end configured to be coupled to one of the plurality of lines, and an axially extending cavity, a reed switch coupled to the body, and a poppet including a poppet body and a magnet disposed in the poppet body, the poppet being biased in a first position and being configured to be moved from the first position to a second position by fluid flowing through the axially extending cavity to activate/deactivate the switch.

The body has an inner wall defining the axially extending cavity, and wherein the wall includes a plurality of flutes that allow flow through the cavity around the poppet.

The flutes have a progressively larger flow area extending from a first end of the cavity to a second end of the cavity.

The indicator panel is configured to be located inside a cab of a vehicle.

The indicator panel is located in a cab of the vehicle.

According to another aspect of the invention, an agricultural apparatus is provided that includes a plurality of flow indicator sensors connectable between a manifold of an agricultural implement and a delivery line for delivering fluid from the manifold to a respective applicator, each flow indicator sensor providing an output indicative of whether or not fluid is flowing through the sensor above or below a prescribed rate, an indicator panel for receiving the outputs from the plurality of flow indicator sensors, the indicator panel including an indicator for each of the plurality of indicators for providing at least one of a visual or an audio indication to an operator indicative of whether or not fluid is flowing through the respective flow indicator sensor above or below the prescribed rate, and a plurality of wires connecting the plurality of flow indicator sensors to the indicator panel.

Each indicator provides a visual indication for the respective flow indicator sensor.

The indicators are light-emitting diodes.

The apparatus further includes a junction box, wherein the plurality of wires includes a wire connecting each of the flow indicator sensors to the junction box and a wire connecting the junction box to the indicator panel.

The wire connecting the junction box to the indicator panel is a mother cable, and wherein the mother cable surrounds a plurality of connection wires, each of the connection wires being coupled to one of the plurality of flow indicator sensors and one of the indicators.

The apparatus further includes a cable having one end coupled to the indicator panel and another end configured to be coupled to a battery to provide power to the indicator panel.

Each flow indicator sensor has a cable coupled thereto that has a connector configured to mate with a corresponding connector coupled to a respective one of the wires.

The indicator panel further includes, a power switch, indicia identifying each of the plurality of applicators, and one or more connectors configured to couple to the wires.

Each flow indicator sensor includes a body having a first end configured to be coupled to the manifold, a second end configured to be coupled to one of the plurality of lines, and an axially extending cavity, a reed switch coupled to the body, and a poppet including a poppet body and a magnet disposed in the poppet body, the poppet being biased in a first position and being configured to be moved from the first position to a second position by fluid flowing through the axially extending cavity to activate/deactivate the switch.

The body has an inner wall defining the axially extending cavity, and wherein the wall includes a plurality of flutes that allow flow through the cavity around the poppet.

The flutes have a progressively larger flow area extending from a first end of the cavity to a second end of the cavity.

According to still another aspect of the invention, a system for delivering fluid to a field using an agricultural implement is provided. The system includes a plurality of flow indicator sensors, each flow indicator sensor being connectable between a manifold and an applicator and configured to provide an output indicative of whether or not fluid is flowing through the sensor at a prescribed rate, an indicator panel for receiving the outputs from of the plurality of flow indicator sensors and for providing at least one of a visual or an audio indication to an operator based on the outputs, a junction box, a plurality of connection cables, each connection cable connecting one of the plurality of flow indicator sensors to the junction box, and a mother cable connecting the junction box to the indicator panel.

According to a further aspect of the invention, a method for detecting an interruption in fluid flow from a fluid source to one or more applicators of a plurality of applicators and for notifying an operator of the interruption is provided. The method includes directing fluid from the fluid source through a plurality axially extending cavities of a plurality of flow indication sensors corresponding to respective applicators, detecting if the fluid is flowing through the plurality of flow indication sensors at a prescribed rate, and providing at least one of a visual or an audio indication via indicators corresponding to respective applicators if the fluid is flowing through one or more of the flow indication sensors below the prescribed rate, wherein if the fluid is flowing through one of the axially extending cavities at the prescribed rate, a magnet in the axially extending cavity is moved from a first position to a second position to activate a reed switch, thereby deactivating the corresponding indicator, and wherein if the fluid is flowing through one of the axially extending cavities below the prescribed rate, the magnet in the axially extending cavity is moved to the first position thereby deactivating the reed switch and activating the corresponding indicator.

The foregoing and other features of the invention are hereinafter described in greater detail with reference to the accompanying drawings.

### BRIEF DESCRIPTION OF THE DRAWINGS

FIG. 1 is a schematic view of an agricultural distribution system;

FIG. 2 is a schematic view of an exemplary agricultural distribution system according to the invention;

FIG. 3 is a front view of an exemplary indicator panel according to the invention;

FIG. 4 is a side cross-section view of an exemplary flow indication sensor according to the invention showing a poppet in a first position.

FIG. 5 is a perspective cross-sectional view of the exemplary flow indication sensor showing the poppet in the first position.

FIG. 6 is a side cross-sectional view of the exemplary flow indication sensor showing the poppet in a second position.

FIG. 7 is a perspective cross-sectional view of the exemplary flow indication sensor showing the poppet in the second position.

FIG. 8 is a side cross-section view of another exemplary flow indication sensor according to the invention showing a shuttle in a first position.

FIG. 9 is a perspective cross-sectional view of the exemplary flow indication sensor showing the shuttle in the first position.

FIG. 10 is a side cross-sectional view of the exemplary flow indication sensor showing the shuttle in a second position.

FIG. 11 is a perspective cross-sectional view of the exemplary flow indication sensor showing the shuttle in the second position.

### DETAILED DESCRIPTION

The principles of the present application have particular application to agricultural systems for delivering a fluid, such as liquid anhydrous ammonia, to a field and for detecting an interruption in the flow of the fluid through applicators in a tool bar, and thus will be described below chiefly in this context. It will of course be appreciated, and also understood, that the principles of the invention may be useful in other fluid applications where it is desirable to monitor the flow of fluid through a conduit.

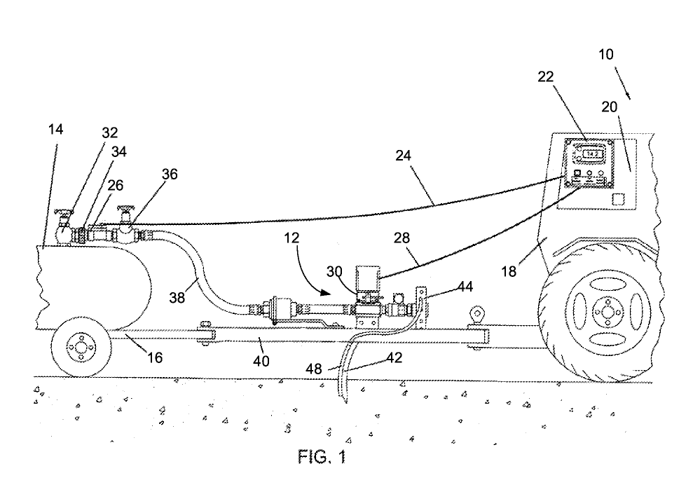

Referring now in detail to the drawings and initially to FIG. 1, a vehicle 10, such as a tractor, is shown connected to a tool bar 12, which is coupled to a nurse tank 14 carried on a frame 16. The vehicle 10 includes a cab 18 having a control station 20 and a control panel 22. Lines 24 may connect the control panel 22 to a flow meter 26 to display a flow rate on the control panel and lines 28 may connect the control panel 22 to a flow regulator 30.

The nurse tank 14 may be any suitable tank that contains a fluid, such as pressurized liquid anhydrous ammonia. The tank 14 includes a withdrawal valve 32 through which the liquid exits the tank 14. The withdrawal valve 18 is coupled to the flow meter 26 by a suitable connector 34, and the flow meter 26 is coupled to a valve 36. The valve 36 is coupled to a line 38, such as a hose by a suitable connector, and the hose 38 is coupled to the tool bar 12.

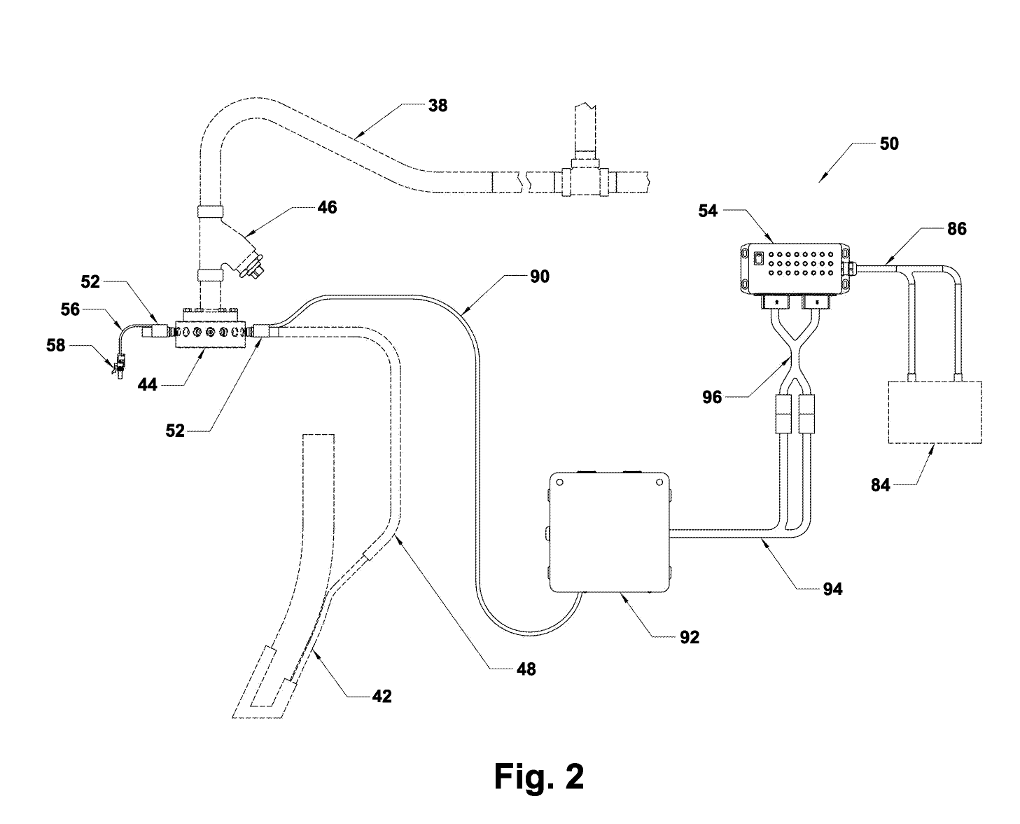

The tool bar 12 includes a frame 40 coupled to the frame 16 and the vehicle 10, and a plurality of applicators 42, herein referred to as knives for tilling soil. The anhydrous ammonia is delivered from the nurse tank 14 through the hose 38 to a manifold 44 of the tool bar 12. An inline filter 46 (FIG. 2) may be provided between hose 38 and the manifold 44. The fluid is then delivered from the manifold 44 to lines 48, such as flexible hoses, extending from the manifold 44 to each knife 42 to distribute the anhydrous ammonia into the soil to serve as fertilizer.

Turning now to FIG. 2, an exemplary system for delivering fluid to the field is illustrated generally at reference numeral 50. The system 50 includes the plurality of laterally spaced knives 42, the manifold 44 connectable to a source of fluid, such as the nurse tank 14, the plurality of lines 48 connecting the manifold 44 to the knives 42, a plurality of flow indicator sensors 52, and an indicator panel 54.

The plurality of flow indicator sensors 52, which will be discussed in detail below, provide an output to the indicator panel 54 indicative of whether or not fluid is flowing through the sensor at a prescribed rate. In this way, an operator may be notified of which knife 42 has a restriction, thereby preventing striping, which is characterized by rows of crops appearing malnourished and producing less crop yield due to the flow of anhydrous ammonia being restricted.

Each of the plurality of flow indicator sensors 52 is connectable between the manifold 44 and a respective one of the plurality of lines 48. Each flow indicator sensor 52 may be connected to the respective line 48 in any suitable manner, for example, each sensor 52 may be coupled to a line 56, which is coupled to a suitable electrical connector 58. The connector 58 is configured to mate with a corresponding connector (not shown) that is coupled to a wire 90. In this way, the length of the lines 48 may be adjusted depending on a distance the respective knives 42 are from the manifold 44.

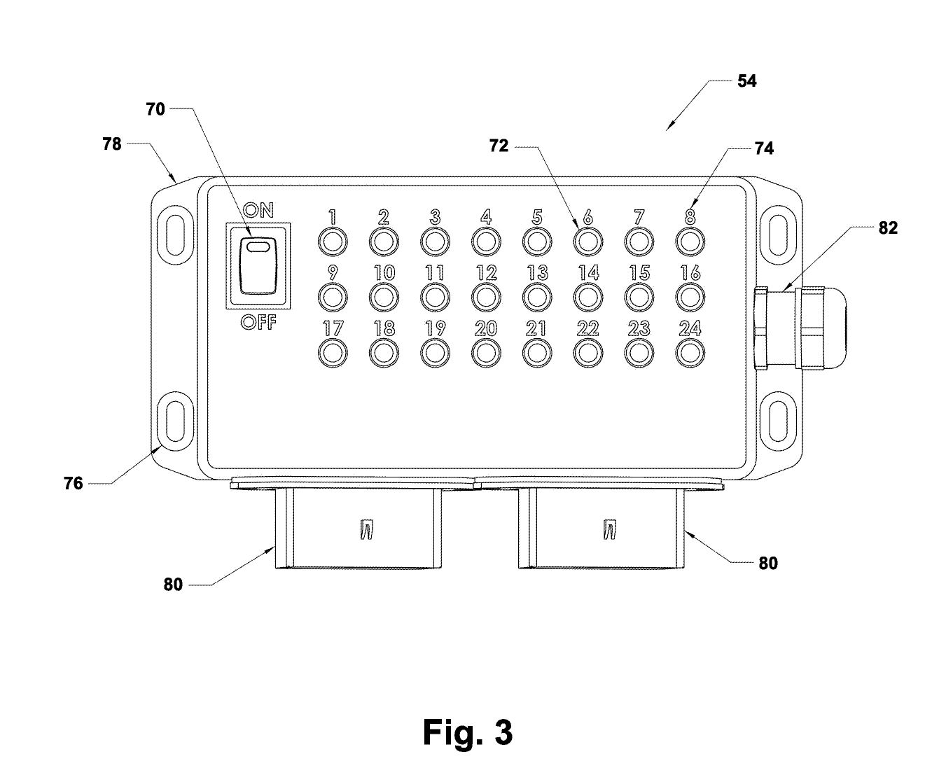

Referring now to FIGS. 2 and 3, the indicator panel 54 is provided for receiving the outputs from the plurality of flow indicator sensors 52, for example as signals, and for providing at least one of a visual or an audio indication to an operator based on the signals. The indicator panel 54 includes a power switch 70 for turning the indicator panel 54 on/off, a plurality of indicators 72 each corresponding to one of the flow indicator sensors 52, indicia 74 identifying respective flow indicator sensor 52 connected to respective indicators 72, mounting holes 76, mother cable connectors 80, and a power connector 82. The mounting holes 76 are provided on flanges 78 for mounting the indicator panel 54 in the cab of the vehicle 10, for example in front of an operator using suitable fasteners. The power connector 82 are provided for connecting the indicator panel 54 to a power source, such as a battery 84 of the vehicle 10 via a cable 86.

The plurality of indicators 72 may be lights, such as light-emitting diodes, corresponding respectively to one of the flow indicator sensors 52. When the fluid flowing through the flow indicator sensors 52 is below the prescribed rate, for example, through the sensor 52 coupled to the indicator 72 identified by the number 8 in FIG. 3, the indicator 72 may provide a visual indication to the operator. The visual indication notifies the operator that there is a clog in the knife 42 connected to the indicator 72 identified by the number 8, thereby allowing the operator to stop the vehicle 10 and clear the clog.

The plurality of indicators 72 are respectively coupled to the plurality flow indicator sensors 52 by respective wires 90. The wires 90 may directly couple the flow indicator sensors 52 to the indicators 72 or be coupled to a junction box 92, for example. As shown in FIG. 2, the wires 90 may have one end coupled to respective flow indicator sensors 52 and another end coupled to the junction box 92. The wires 90 are connected in the junction box in any suitable manner to a mother cable 94, which is coupled to the mother cable connectors 80.

The mother cable 94 may be directly coupled to the mother cable connectors 80 or be coupled to a cable 96 in any suitable manner, which is coupled to the connectors 80 in any suitable manner. The cable 96 may be coupled to the mother cable connectors 80 and extend, for example, to an exterior of the cab 18 of the vehicle 10 to allow the mother cable 94 to be conveniently connected/disconnected from the cable 96. The mother cable 94 and the cable 96 may enclose a respective plurality of wires that correspond to the wires 90 to couple the flow indicator sensors 52 to the respective indicators 72.

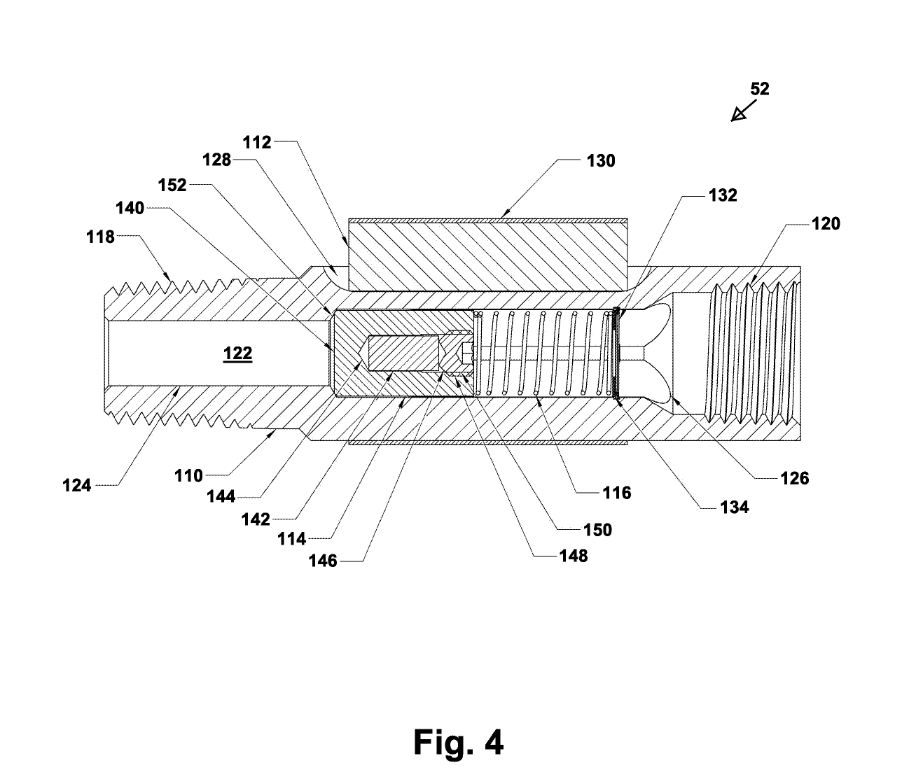

Turning now to FIGS. 4-7, one of the plurality of flow indicator sensors 52 is illustrated in detail. The flow indicator sensor 52 includes a body 110, a switch 112, a poppet 114, and a resilient member 116. The body 110 may be made of any suitable material, such as aluminum and has a first end 118 configured to be coupled to the manifold 44, a second end 120 configured to be coupled to one of the plurality of lines 48, an axially extending cavity 122 defined by an inner wall 124 of the body 110, and a plurality of flutes 126 in the inner wall 124 extending at least partially along a length of the cavity 122. The first and second ends 118 and 120 may be coupled to the manifold 44 and line 48, respectively, in any suitable manner, for example the first end 118 may have a male threaded portion that mates with a female threaded portion on the manifold 44 and the second end 120 may have a female threaded portion that mates with a male threaded portion on the line 48. The flutes 126 have a flow area that increases from a first end of the flute near the first end 118 of the body 110 to a second end of the flute near the second end 120.

The switch 112 is disposed in a recess 128 in the body 110 and coupled to the body 110 in any suitable manner, such as by a sleeve 130 which may be secured to the body 110 in any suitable manner, such as by shrink fitting. The switch 112 may be any suitable switch, such as a magnetic reed switch coupled to one of the plurality of lines 90 to provide the output to the respective indicator 72.

The switch 112 may be activated/deactivated by movement of the poppet 114 from a first position to a second position. The poppet 114 is disposed in the axially extending cavity 122 and biased in the first position by the resilient member 116, which may be any suitable member such as a spring that is retained in the cavity by a retainer 132, such as a retainer ring. A washer 134 may also be included that serves as a seat for the resilient member 116. The retainer 132 may abut a backside of the washer 134 to retain the resilient member 116 and washer 134. The poppet 114 includes a body 140 which may be made of any suitable material, such as polytetrafluoroethylene, a magnet 142 disposed in a bore 144 in the body 140, and a retainer 146, such as a retainer screw secured in the bore 144 to retain the magnet 142. The retainer 146 is secured to the bore 144 in any suitable manner, such as by threads 148 that mate with threads 150 in the bore 144.

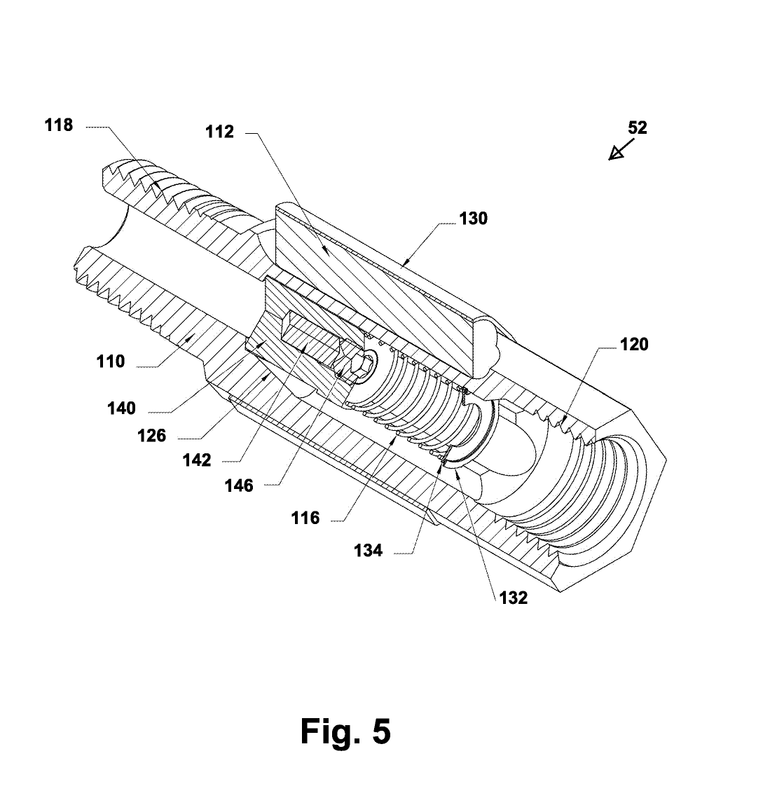

When the poppet 114 is in the first position shown in FIGS. 4 and 5, an end of the poppet 114 closest the first end 118 of the body 110 abuts a shoulder 152 in the axially extending cavity 122. The shoulder 152 prevents the poppet 114 from advancing further towards the first end 118. When the poppet 114 is seated against the shoulder 152, the fluid is flowing through the axially extending cavity 122 below the prescribed rate, such as no flow or low flow, and thereby the switch 112 is deactivated and the indicator 72 corresponding to the flow indicator sensor 52 indicates to the operator that fluid is flowing through cavity 122 below the prescribed rate, for example by activating the light-emitting diode. This may occur before the operator has begun use of the tool bar 12, when there is a clog in the knife 42 corresponding to the flow indicator sensor 52, a broken supply line, etc.

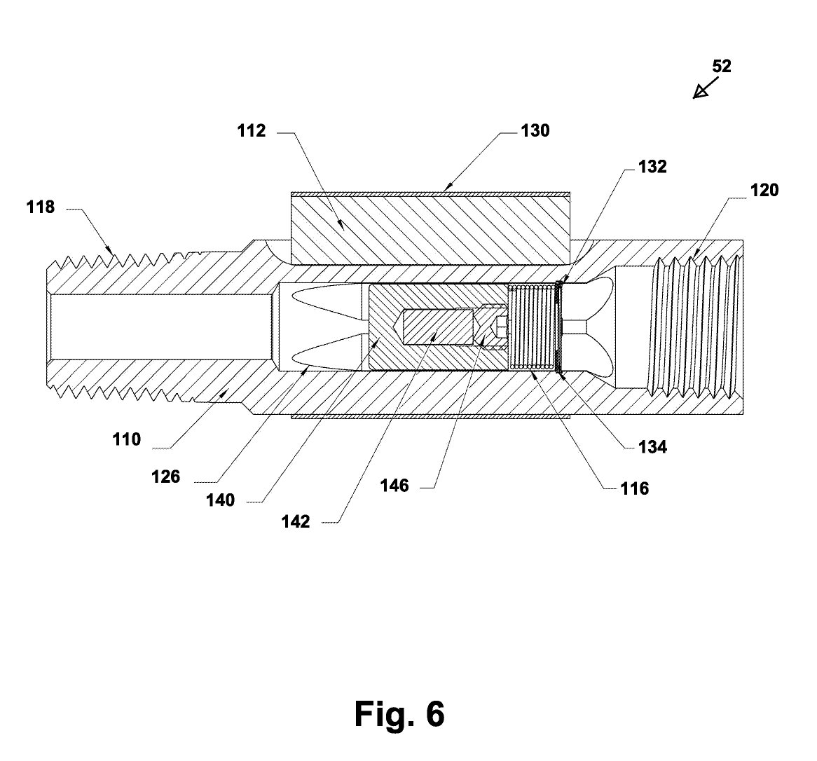

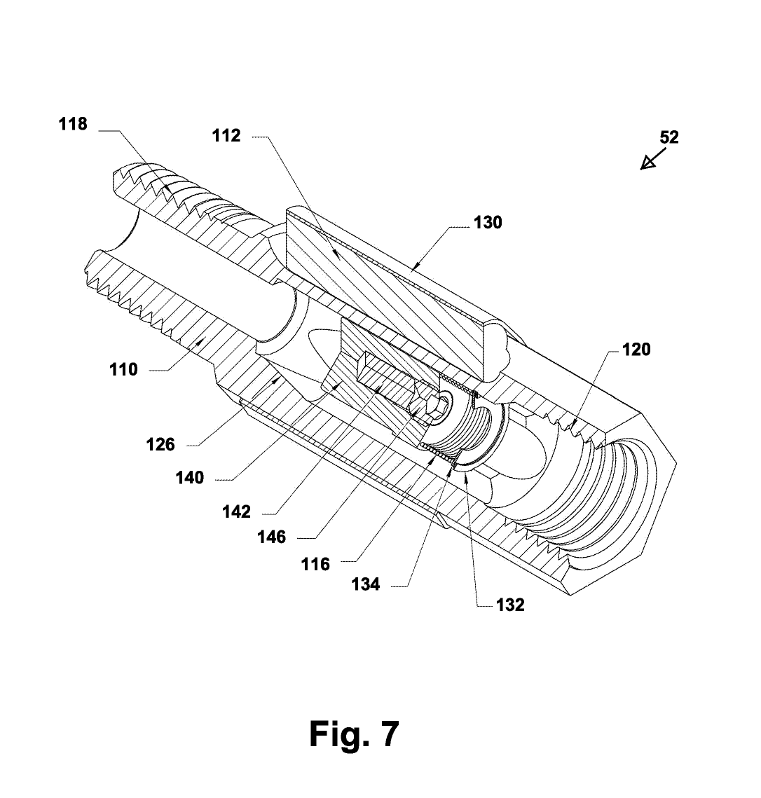

When fluid from the manifold 44 flows through the axially extending cavity 122 above the prescribed rate, the fluid moves the poppet 114 to the second position against the force of the resilient member 116, as shown in FIGS. 6 and 7. As the poppet 114 is moved to the second position, the magnet 142 activates the switch 112 and the indicator 72 corresponding to the flow indicator sensor 52 indicates to the operator that fluid is flowing through the cavity 122, for example by deactivating the light-emitting diode. The fluid flowing through the cavity 122 flows around the poppet 114 through the flutes 126.

By providing the flutes 126 with progressively larger flow areas from one end to another, the flow indicator sensor 52 can be more sensitive at lower flow rates and reduce the pressure drop across the poppet 114 at higher flow rates due to the fact that the flutes 126 flow area gets larger around the poppet 114 as the poppet 114 moves against the resilient member 116. The flute 126 configuration also allows for stronger resilient members 116 to be used, which increases the resilient members 116 resistance to malfunction due to debris in the axially extending cavity 122 at lower flow rates.

Referring now to the operation of the system in detail, when the withdrawal valve 32 is closed, for example when the tool bar 12 is elevated, the fluid in the nurse tank 14 does not flow through the plurality of flow indicator valves 52, and therefore the reed switch 112 is not activated and the plurality of indicators 72 indicate to operator the flow is below the prescribed rate, for example by lighting all of the light-emitting diodes.

When the tool bar 12 is lowered so that the unrestricted knives 42 enter the soil, the withdrawal valve 32 is fully opened and the fluid flows through the flow indicator sensors 52 above the prescribed rate. The fluid moves the poppets 114 to their second positions, thereby activating the reed switches 112 and providing an indication to the operator that the flow is above the prescribed rate, for example by turning off the light-emitting diodes.

As the vehicle 10 moves down a field, the fluid is delivered to the soil through via the knives 42, and the operator may view the indicator panel 54 to determine if flow to any of the knives 42 becomes interrupted. If the flow of fluid through one or more of the flow indicator sensors 52 becomes interrupted, the corresponding indicators 72 will light up to notify the operator that there is an interruption. In an embodiment, the operator can then toggle optional switches, which may be the indicators 72 or associated with the respective indicators 72 to a no flow position, which will turn the indicators 72 off.

Once the operator stops the vehicle 10 and shuts off the flow of fluid to the tool bar 12, such as by closing the withdrawal valve 32, the operator can remove the interruptions, such as by unclogging the clogged knifes 42. With the flow shut off, the indicators 72 will light up except for the indicators 72 that were toggled to the no flow position. In this way, the operator can be reminded of which flow indicator sensor 52 showed and interruption. When the operator resumes delivering fluid to the soil, the operator can toggle the switches associated with the previously clogged indicators 72 from the no flow position to allow for the respective flow indicator sensors 52 to be monitored.

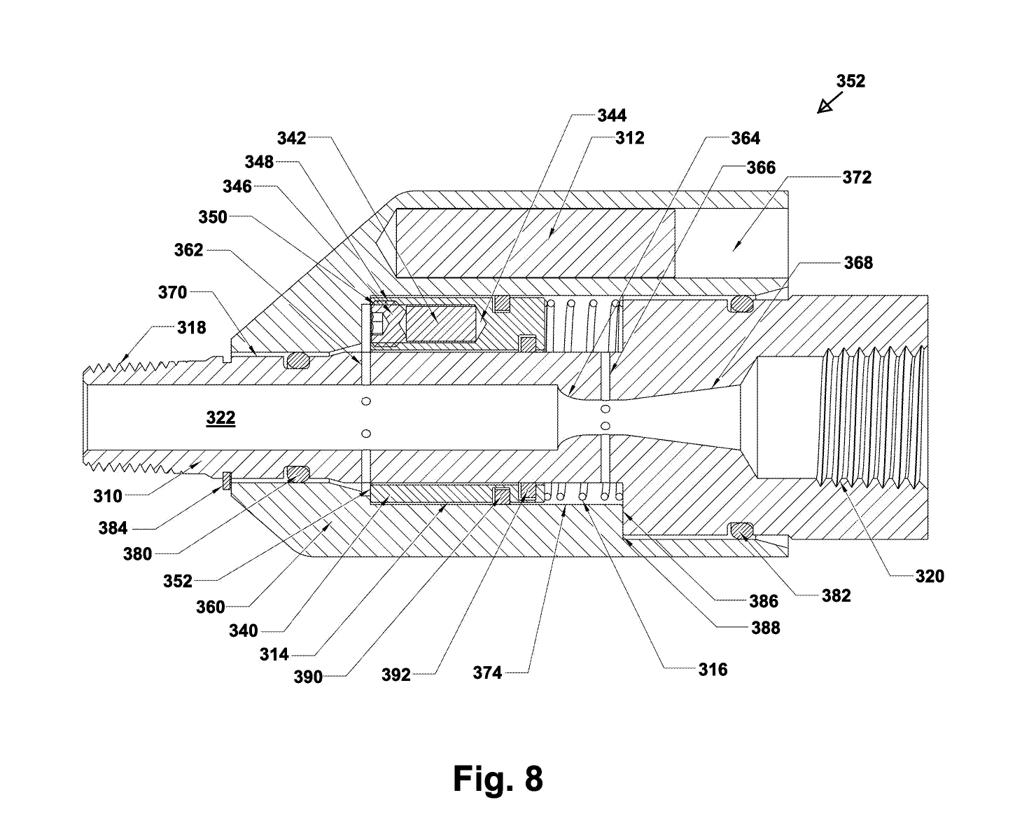

Turning now to FIGS. 8-11, an exemplary embodiment of the flow indicator sensor is shown at 252. The flow indicator sensor 252 is substantially the same as the above-referenced flow indicator sensor 52, and consequently the same reference numerals but indexed by 200 are used to denote structures corresponding to similar structures in the flow indicator sensor. In addition, the foregoing description of the flow indicator sensor 52 is equally applicable to the flow indicator sensor 252 except as noted below. Moreover, it will be appreciated upon reading and understanding the specification that aspects of the flow control valves may be substituted for one another or used in conjunction with one another where applicable.

Referring to FIG. 8, one of the plurality of flow indicator sensors 252 is illustrated. The flow indicator sensor 252 includes a first body 310, a switch 312, a shuttle 314, a resilient member 316, and a second body 360. The first body 310 has a first end 318 configured to be coupled to the manifold 44, a second end 320 configured to be coupled to one of the plurality of lines 48, an axially extending cavity 322, a first plurality of radially outwardly extending channels 362, a venturi 364, a second plurality of radially outwardly extending channels 366 downstream of the channels 362 and the venturi 364, and a diverging nozzle 368.

The second body 360 includes an axially extending cavity 370 and a bore 372 in which the switch 312 is disposed. The second body 360 surrounds the first body 310 such that a chamber 374 is formed in the cavity 370 between the first and second bodies 310 and 360, wherein the chamber 374 is fluidly connected to the channels 362 and 366. The first and second bodies 310 and 360 are sealed to one another by suitable seals, such as o-rings 380 and 382. The first body 310 is prevented from moving axially relative to the second body 360 in a first direction by a retainer 384 and in a second direction opposite the first direction by a shoulder 386 of the first body 310 that abuts a ledge 388 in the second body 360.

The shuttle 314 surrounds the first body 310 and is disposed in the chamber 374 with the resilient member 316. The shuttle 314 is biased in the first position by the resilient member 316 and movable to a second position to activate/deactivate the switch 312. Split rings 390 and 392 are provided in respective grooves in the body 340 of the shuttle 314 to close gaps between the first body 310 and the second body 360, thereby enhancing the efficiency of the pressure differential across the shuttle 314. The shuttle 314 is rotatable with the second body 360, such as when the second body 360 rotates relative to the first body 310, to provide a positive location of the magnet 342, for example by an axial offset between the shuttle 314 and the first body 310.

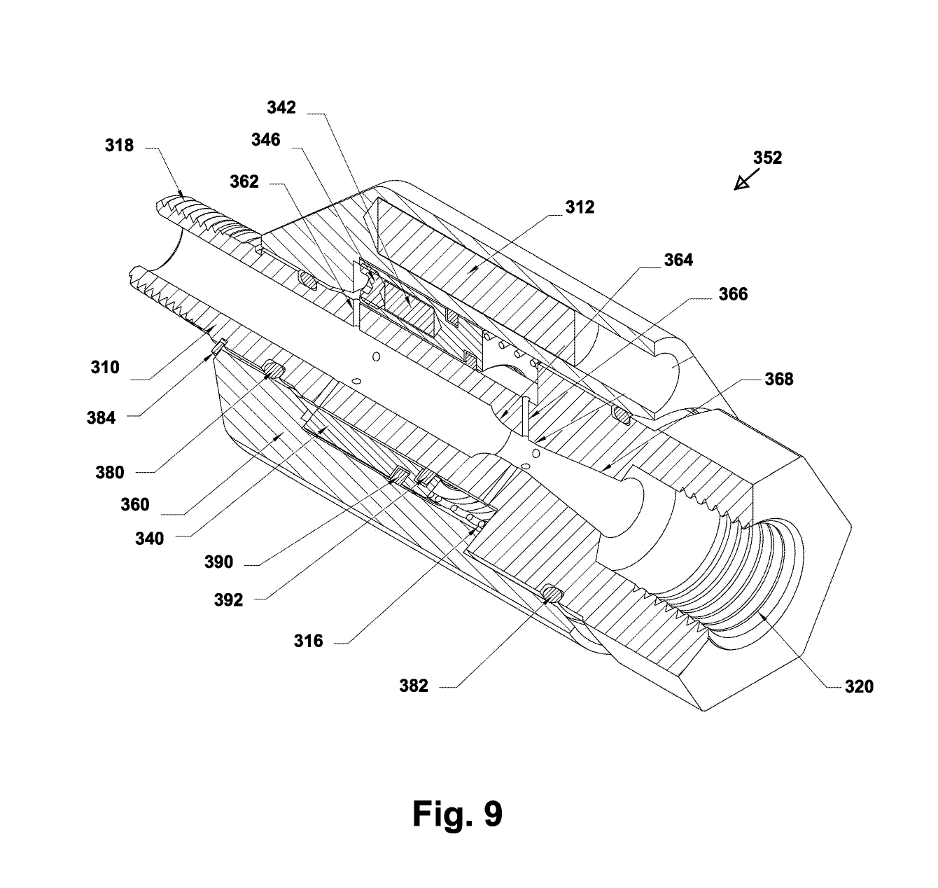

When the shuttle 314 is in the first position shown in FIGS. 8 and 9, an end of the shuttle 314 closest the first end 318 of the body 310 abuts a shoulder 352 in the axially extending cavity 370. When the shuttle 314 is seated against the shoulder 352, the fluid is flowing through the axially extending cavity 322 below the prescribed rate, such as no flow or low flow, and the switch 312 is deactivated. The indicator 72 corresponding to the flow indicator sensor 352 thereby indicates to the operator that fluid is flowing through cavity 322 below the prescribed rate, for example by activating the light-emitting diode.

When fluid from the manifold 44 flows through the axially extending cavity 322, the fluid flows through the venturi 364, where the fluid pressure is reduced and the velocity of the fluid is accelerated, and then through the divergent nozzle 368 where some of the energy lost is recovered and a pressure differential is created across the shuttle 314. The pressure differential is communicated from the axially extending cavity 322 to the chamber 374 via the channels 362 and 366. The resilient member 316 acts to resist the pressure differential across the shuttle 314 and to move the shuttle 314 to the first position when there is no flow in the axially extending cavity 322.

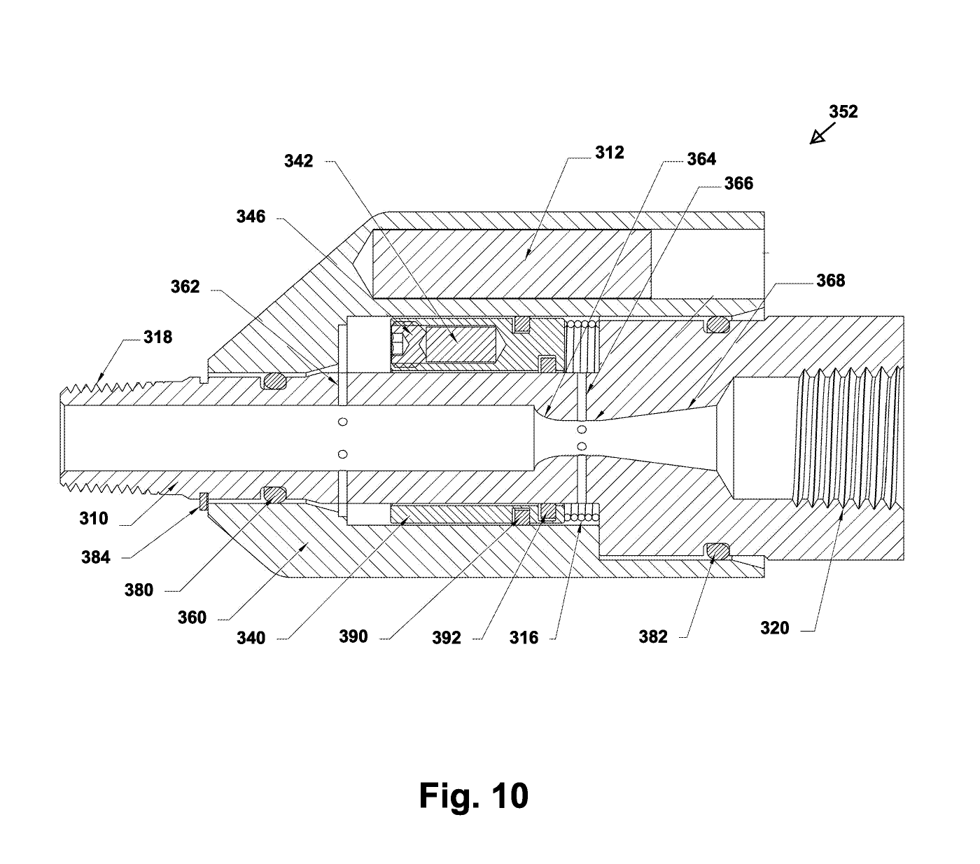

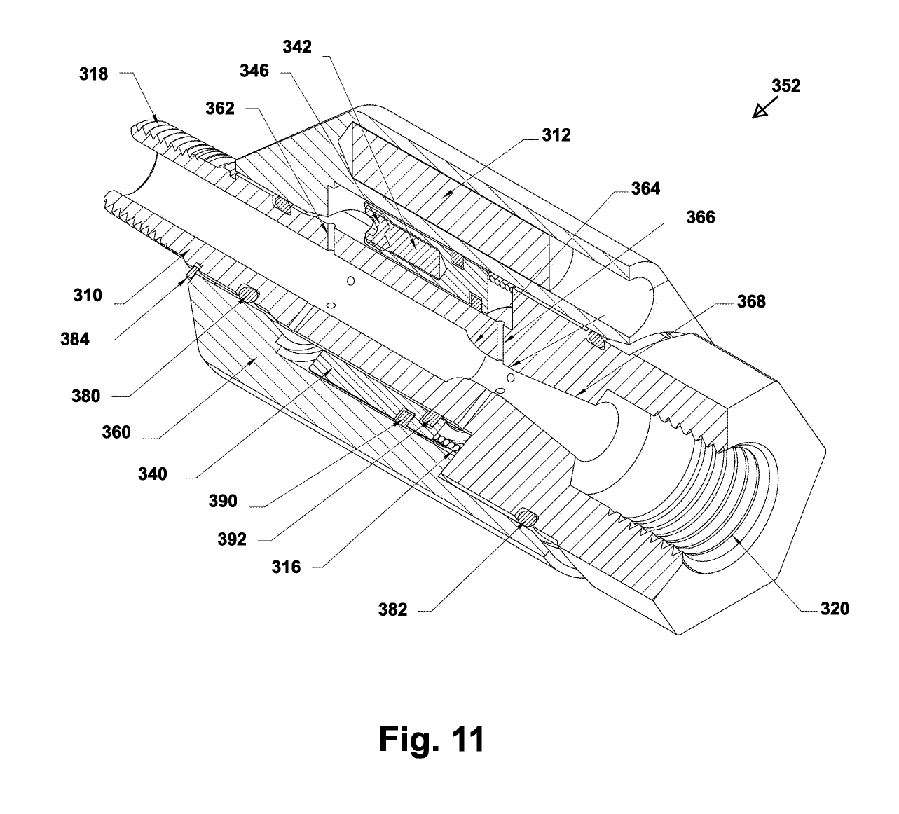

When fluid from the manifold 44 flows through the axially extending cavity 322 above the prescribed rate, the pressure differential causes the shuttle 314 to move to the second position against the force of the resilient member 316, as shown in FIGS. 10 and 11. As the shuttle 314 is moved to the second position, the magnet 342 activates the switch 312 and the indicator 72 corresponding to the flow indicator sensor 252 indicates to the operator that fluid is flowing through the cavity 322 above the prescribed rate. The flow across the shuttle 314 is small in relation to flow through the axially extending cavity 322, thereby reducing the chance that debris entrained in the fluid will enter the chamber 374 and cause sensor failure due to the shuttle 314 sticking in either the first or second position.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A system for delivering fluid to a field using an agricultural implement, the system including:
a plurality of laterally spaced applicators;
a manifold connectable to a source of fluid to be delivered to the field;
a plurality of lines, each line connecting the manifold to a respective one of the plurality of applicators;
a plurality of flow indicator sensors, each flow indicator sensor being connectable between the manifold and a respective one of the plurality of lines and configured to provide an output indicative of whether or not fluid is flowing through the sensor at a prescribed rate; and
an indicator panel for receiving the output from the plurality of flow indicator sensors and for providing at least one of a visual or an audio indication to an operator based on the outputs.

2. The system according to claim 1, wherein the indicator panel provides a visual indication for each of the plurality of flow indicator sensors based on the outputs of the respective flow indicator sensors.

3. The system according to claim 1, wherein the indicator panel includes an indicator for each of the plurality of flow indicator sensors.

4. The system according to claim 3, wherein the indicators are light-emitting diodes.

5. The system according to claim 1, further including wires connecting the plurality of flow indicator sensors to the indicator panel.

6. The system according to claim 5, further including a junction box, wherein the wires include a wire connecting each of the flow indicator sensors to the junction box and a wire connecting the junction box to the indicator panel.

7. The system according to claim 1, further including a cable having one end coupled to the indicator panel and another end configured to be coupled to a battery to provide power to the indicator panel.

8. The system according to claim 5, wherein each flow indicator sensor has a cable coupled thereto that has a connector configured to mate with a corresponding connector coupled to a respective one of the wires.

9. The system according to claim 5, wherein the indicator panel further includes:
a power switch;
indicia identifying each of the plurality of applicators; and
one or more connectors configured to couple to the wires.

10. The system according to claim 1, wherein each flow indicator sensor includes:
a body having a first end configured to be coupled to the manifold, a second end configured to be coupled to one of the plurality of lines, and an axially extending cavity;
a reed switch coupled to the body; and
a poppet including a poppet body and a magnet disposed in the poppet body, the poppet being biased in a first position and being configured to be moved from the first position to a second position by fluid flowing through the axially extending cavity to activate/deactivate the switch.

11. The system according to claim 10, wherein the body has an inner wall defining the axially extending cavity, and wherein the wall includes a plurality of flutes that allow flow through the cavity around the poppet.

12. The system according to claim 11, wherein the flutes have a progressively larger flow area extending from a first end of the cavity to a second end of the cavity.

13. A vehicle in combination with the system according to claim 1, wherein the indicator panel is located in a cab of the vehicle.

14. An agricultural apparatus for use in the system according to claim 1, the apparatus including:
a plurality of flow indicator sensors connectable between a manifold of an agricultural implement and a delivery line for delivering fluid from the manifold to a respective applicator, each flow indicator sensor providing an output indicative of whether or not fluid is flowing through the sensor above or below a prescribed rate;
an indicator panel for receiving the outputs from the plurality of flow indicator sensors, the indicator panel including an indicator for each of the plurality of indicators for providing at least one of a visual or an audio indication to an operator indicative of whether or not fluid is flowing through the respective flow indicator sensor above or below the prescribed rate; and
a plurality of wires connecting the plurality of flow indicator sensors to the indicator panel.

15. The agricultural apparatus according to claim 14, wherein each indicator provides a visual indication for the respective flow indicator sensor.

16. The agricultural apparatus according to claim 14, wherein each flow indicator sensor includes:
a body having a first end configured to be coupled to the manifold, a second end configured to be coupled to one of the plurality of lines, and an axially extending cavity;
a reed switch coupled to the body; and
a poppet including a poppet body and a magnet disposed in the poppet body, the poppet being biased in a first position and being configured to be moved from the first position to a second position by fluid flowing through the axially extending cavity to activate/deactivate the switch.

17. The agricultural apparatus according to claim 16, wherein the body has an inner wall defining the axially extending cavity, and wherein the wall includes a plurality of flutes that allow flow through the cavity around the poppet.

18. The system according to claim 17, wherein the flutes have a progressively larger flow area extending from a first end of the cavity to a second end of the cavity.

19. A system for delivering fluid to a field using an agricultural implement, the system including:
a plurality of flow indicator sensors, each flow indicator sensor being connectable between a manifold and an applicator and configured to provide an output indicative of whether or not fluid is flowing through the sensor at a prescribed rate;
an indicator panel for receiving the outputs from of the plurality of flow indicator sensors and for providing at least one of a visual or an audio indication to an operator based on the outputs;
a junction box;
a plurality of connection cables, each connection cable connecting one of the plurality of flow indicator sensors to the junction box; and
a mother cable connecting the junction box to the indicator panel.

20. A method for detecting an interruption in fluid flow from a fluid source to one or more applicators of a plurality of applicators and for notifying an operator of the interruption, the method including:
directing fluid from the fluid source through a plurality axially extending cavities of a plurality of flow indication sensors corresponding to respective applicators;
detecting if the fluid is flowing through the plurality of flow indication sensors at a prescribed rate; and
providing at least one of a visual or an audio indication via indicators corresponding to respective applicators if the fluid is flowing through one or more of the flow indication sensors below the prescribed rate,
wherein if the fluid is flowing through one of the axially extending cavities at the prescribed rate, a magnet in the axially extending cavity is moved from a first position to a second position to activate a reed switch, thereby deactivating the corresponding indicator, and
wherein if the fluid is flowing through one of the axially extending cavities below the prescribed rate, the magnet in the axially extending cavity is moved to the first position thereby deactivating the reed switch and activating the corresponding indicator.
